(19) United States
(12) Patent Application Publication
(10) Pub. No.: US 2009/0196958 A1
(43) Pub. Date: Aug. 6, 2009

(54) Breading and breading mix comprising crunchy corn ingredient, food products created therewith, and methods related thereto

(76) Inventor: Mark Sosebee, Dawsonville, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 11/823,423

(22) Filed: Jun. 27, 2007

Related U.S. Application Data
(60) Provisional application No. 60/926,151, filed on Apr. 25, 2007.

(51) Int. Cl. A23P 1/08; A23D 7/00; A23L 1/05; A23L 1/10; A23L 1/20; A23L 1/22; A23L 1/237

(52) U.S. Cl. 426/92; 426/291; 426/601; 426/613; 426/618; 426/622; 426/634; 426/638; 426/649; 426/661

(57) ABSTRACT

A breading and breading mix comprising a crunchy corn-flavored ingredient, food products created therewith, and methods related thereto, wherein a unique visual experience results from variation in particle size and arrangement, wherein a unique smell and taste experience results from breading flavoring, and from preferred marination processes, and wherein virtually any meat, vegetable or food based product can be adapted into a shelf stable, refrigerated, or frozen Mexican taco-related organoleptic experience.

### CROSS-REFERENCE AND PRIORITY CLAIM TO RELATED APPLICATIONS

The present United States Non-Provisional patent application cross-references and claims priority to related United States Provisional Patent Application entitled “Breading and Breading Mix Comprising Crunchy Corn Ingredient, Food Products Created Therewith, and Methods Related Thereto,” filed on Apr. 25, 2007, having assigned Ser. No. 60/926,151, and United States Provisional Patent Application entitled “Breading and Breading Mix Comprising Crunchy Corn Ingredient and Food Products Created Therewith,” filed on Feb. 13, 2007, having assigned Ser. No. 60/901,604.

### TECHNICAL FIELD

The present invention relates generally to edible breading and food products created therewith, and more specifically, to breading and breading mix comprising a crunchy corn-flavored ingredient, food products created therewith, and methods related thereto.

### BACKGROUND

It is well recognized that individuals prefer a variety of food tastes and genres, and that variation in food coatings can offer an opportunity to present multiple flavor selections for a given base food. For example, restaurants frequently offer a plurality of coating styles for chicken wings, such as lemon and pepper, buffalo hot sauce, barbeque, and the like, in order to accommodate the taste preferences of diners. Even fast food establishments offering a limited number of base food products are known to offer a variety of sauce accompaniments for dipping. Unfortunately, dipping sauce can serve as a nothing more than a disguise for a bland food product. Further, sauces are generally not conducive for eating on the run and/or in certain environments, wherein fear of spillage can lead to consumers foregoing flavor options in order to avoid potential mess.

In order to accommodate the recognized desire for flavor variety, producers of prepared food products also frequently rely upon infusion of spices and flavorings, such as via marinating, and upon coating, such as with breading or batter, with ingredients selected to deliver a particular flavor combination and/or gastronomic experience. This array of taste preferences, coupled with individual variation in taste sensitivity, further complicates the food product ingredient selection process.

That is, differences in the number and concentration of taste buds on the tongue, a heritable characteristic, relate to individual taste sensitivity. Chemical receptors have been identified, wherein the sense of taste essentially results from the excitation thereof. None of the basic tastes, salty, sour, sweet, bitter, and umami, excite via the same chemical, and different chemicals that taste the same generally have variation in thresholds for taste detection.

The sense of smell, too, profoundly influences taste perception. In fact, some flavors are primarily recognized through smell, such as coffee and chocolate. That is, both smell and taste fall under the broad heading of chemosensation. Olfactory cells are stimulated by odors and are found in the nose. By contrast, gustatory cells are found in the mouth and throat; surface cells like taste buds send taste messages to the brain via associated nerves. Another chemosensory mechanism resides in nerve endings, such as those on the moist surfaces of the eyes, nose, mouth and throat, whereby sensations are identified. False temperature sensations, such as coolness from “fresh” or “minty” flavorings and heat from “hot” or “spicy” additives, are perceived phenomenon triggered after nerve cell activation by particular foods.

Texture, too, contributes to flavor sensation. One school of thought finds overall taste to thus be a psychological state and experience as opposed to just a chemical reaction in tongue tissue, referring to taste experiences as flavor profiles. That is, the basic taste concept does not account for more complex reactions, sometimes referred to as “mouthfeel.” A flavor profile does generally refer to stimuli directly affecting the tongue, but also involves other sensory perceptions, including olfaction and somatosensory sensations. Thus, it is the organoleptic qualities, or sensory properties of a food product, involving taste, color, odor and feel, that define the overall flavor profile and gastronomic experience, via visual examination, feeling and smelling thereof.

Some edible food coatings, such as breedings, are selected for use because a particular preparation method delivers a particular crunch, or crispness, or for delivery of a particular nutritional component. For prepared foods that are stored frozen prior to cooking, successful delivery of cooked product that maintains a fresh and crunchy appearance can present a challenge. That is, the most nutritionally focused and/or flavorfully appealing coatings frequently may not maintain texture upon freezing and reheating and/or microwaving. Conversely, the breading presenting the most sustainable texture frequently does not deliver the best taste.

Presently available breadcrumb and breading mix derives from baked bread as crumb particles of various sieve sizes, or from electrolytic processes offering flakes, commonly referred to as Japanese style crumb. Foods coated with such breadcrumbs typically present a relatively uniform exterior surface, especially if prepared and subjected to frozen storage and reheating, wherein deviation and variation in crumb constituents is generally not sought after. On the contrary, uniform coating is typically the goal. As experimentation with breadcrumb base ingredients and processes of preparation has continued, new efforts have followed, but such methods rely upon a virtually complete saturation of the base food item with breading mix in order to define the desired resultant food product. Relying upon such saturation in order to solve food nutrition and/or flavoring issues is disadvantageous in view of the present invention.

A need therefore exists for a breading and breading mix, and food products created therewith, and the methods of preparation thereof, capable of overcoming the limitations of the prior art by enabling a visual and taste-pleasing composition in combination with a unique texture to deliver a particular organoleptic experience via cost-effective methodologies that avoid the need for saturation, yet enable delivery of targeted chemosensory sensations.

### BRIEF SUMMARY OF THE INVENTION

Briefly described, in a preferred embodiment, the present invention overcomes the above-mentioned limitations and meets the recognized need by providing an edible food coating and methods thereof presenting the experience of corn-based, crushed taco shells, wherein the present invention relates to bread crumbs and particularly a breading mixture preferably comprising tortilla chips (preferably of yellow whole corn and vegetable oil), bleached wheat flour, sugar, yeast and salt, wherein the tortilla chip component is preferably 1% to 59% of the total mixture, and more preferably approximately 25% to 59%.

According to its major aspects and broadly stated, the present invention in its preferred form is a breading and breading mix comprising a crunchy corn-flavored ingredient, food products created therewith, and methods related thereto, wherein a unique visual experience results from variation in particle size and arrangement, wherein a unique smell and taste experience results from breading flavoring and from preferred marination processes, and wherein virtually any meat, vegetable or food based product can be adapted into a shelf stable, refrigerated, or frozen Mexican taco-related organoleptic experience.

More specifically, the preferred embodiment of the present invention comprises a base food product, preferably with infused spices and flavorings, preferably coated with a batter, and encompassing an outer shell preferably comprising a plurality of spices and crushed and/or flaked tortilla shells, taco shells, white, yellow or blue corn and/or baked or fried corn tortilla chips, or the like, wherein a unique flavor experience is created via taste, smell, texture and feeling.

The preferred food products, when breaded/battered and otherwise coated with the breading and/or breading mix of the present invention, deliver Mexican flavors suitable for dipping into salsa, sour cream, guacamole, and/or cheese dip, can be served in a tortilla wrap, can be cut into pieces and served as salad topping, and/or can be consumed independently of any accompanying sauces, foods, or salad or other base foundations. That is, the preferred food product, according to the present invention, stimulates a particularly preferred assortment and balance of taste receptors defining an experience comprising, for example, energy rich nutrient sweet flavor, aged cheese umami flavor, and electrolyte balanced salty flavor, amongst others. Because the human threshold for tasting substances exhibiting such tastes varies, for example, 0.01M of sodium chloride is the minimum threshold for a salty taste and of sucrose for a sweet taste, and 0.0007M of glutamate for an umami taste, the preferred composition of the present invention has been optimized to enhance testability.

Thus, the preferred chemosensation of the present invention provides for identification of a specifically identifiable smell, taste, and temperature sensation via stimulation of olfactory cells, gustatory cells, and chemosensory mechanisms, and for delivery of particular flavor sensation via a defined textural experience.

Therefore, it is a feature and advantage of the present invention that the preferred combination of edible components deliver a multi-faceted flavor sensation essentially irrespective of the base food to which it is applied.

Another feature and advantage of the present invention is its ability to deliver a heretofore unknown combination of taste, texture, temperature, and odor sensations to produce a taco-like flavor via a breading mix.

Another feature and advantage of the present invention is its ability to present a selected balance of basic tastes via a breading and breading mix applied in light concentration and without saturation.

Yet another feature and advantage of the present invention is its ability to deliver a psychological flavor profile based upon the taste experience.

Still another feature and advantage of the present invention is its ability to influence stimuli directly affecting the tongue, as well as to introduce flavor via olfaction, and to elicit chemical senses, in order to deliver a particular taste.

Yet another feature and advantage of the present invention is its ability to deliver particular organoleptic sensory properties involving taste, color, odor, and feel via visual and textural presentation of food products prepared with the preferred breading and breading mix comprising a crunchy corn-like ingredient.

Another feature and advantage of the present invention is its ability to provide a food product with high grade texture parameters in organoleptic evaluation given, with less than 50%, and even less than 25% addition of the breading to a food base.

Still another feature and advantage of the present invention is it ability to deliver an edible food coating with a variably textured exterior via incorporation of a plurality of non-uniform particle sizes.

Yet another feature and advantage of the present invention is its ability to provide a shelf-stable breading mix adapted for application to virtually any food product.

Still yet another feature and advantage of the present invention is its ability to provide a breading and breading mix for use in coating food products, particularly but not exclusively for food products which are frozen for storage before use.

Yet still another feature and advantage of the present invention is its ability to provide a food product coating that resists deterioration over time during chilled or frozen storage.

Still another feature and advantage of the present invention is its ability to provide a process for making a food product having an outer coating comprised of visible crushed tortilla chip particles, randomly dispersed about a battered interior food component.

Yet still another feature and advantage of the present invention is the ability of the crunchy, corn-/pseudo-corn based food coating to impart a special crispness to a food product and to deliver the perception of an exterior at least partially coated with crushed tortilla chip/taco shell pieces of varying shapes and sizes.

Yet another feature and advantage of the present invention is its adaptation for independent use relative to other food processing steps.

Still another feature and advantage of the present invention is the ability of the breading and breading mix to be applied to, for example, red meats, poultry, seafood, fish, vegetables, mushrooms, cheese, fruit, and the like.

Another feature and advantage of the present invention is its delivery of an unexpectedly desirable organoleptic experience even via minimized concentration of chip-based coating relative to that of prior art compositions.

Yet another feature and advantage of the present invention is its delivery of an unexpectedly desirable textured coating via variation in particle size from 1 mm to 1 inch in length.

These and other objects, features, and advantages of the invention will become more apparent to those ordinarily skilled in the art after reading the following Detailed Description of the Invention and Claims and the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a poultry food product prepared according to a preferred embodiment of the present invention;

FIG. 2 is a partial cut-away view of the poultry food product of FIG. 1;

FIG. 3 is a cross-sectional view of the poultry food product of FIG. 1;

FIG. 4 is a perspective view of a vegetable food product prepared according to an alternate embodiment of the present invention;

FIG. 5 is a perspective view of a fruit food product prepared according to an alternate embodiment of the present invention; and

FIG. 6 is a process flow chart, according to the preferred method of creating a food product with the breading and breading mix of the present invention.

### DETAILED DESCRIPTION OF THE INVENTION

In describing preferred embodiments of the present invention, specific terminology is employed for the sake of clarity. The invention, however, is not intended to be limited to the specific terminology so selected, and it is to be understood that each specific element includes all technical equivalents that operate in a similar manner to accomplish a similar purpose.

The present invention describes compositions for breading and breading mix comprising a crunchy corn-like ingredient, food products created therewith, and methods related thereto. It is important to understand that the compositions and methods of the present invention are suitable for utilization on virtually any food product wherein a Mexican/Tex-Mex and/or taco-like flavor experience would be desirable; therefore, while the breading and breading mix and methods of the present invention are described conveniently with the preferred utilization as a coating for poultry, namely, a chicken finger, the present invention is not limited to application or implementation with only such a food product. Further, while the preferred embodiment describes a prepared food product, the breading and breading mix of the present invention is not intended to be limited to pre-prepared implementation. That is, although pre-preparation of food products is preferred for a plurality of reasons as noted herein, independent provision of the breading and breading mix of the present invention is anticipated in lieu of, or in combination with, provision of a prepared base food product, wherein although preconsumption preparation would be generally more complex than with a fully prepared food product, the overall organoleptic experience provided by the unique composition of the breading and breading mix would remain.

Fried, battered, and battered/breaded foods are extremely popular. Additionally, increasing interest in Mexican and Tex-Mex foods has been recognized. In acknowledgement of these factors, investigative development of the preferred embodiment of the present invention was first focused toward the experimental evaluation of the organoleptic effectiveness of various batter and breading compositions, with targeted testing defining optimum Mexican and/or Tex-Mex composition based upon texture, taste, and appearance, and to most efficacious and favorable methods of use.

Thus, comparative studies were conducted in an effort to validate the authenticity of the taste and appearance of a food product coated with the breading and breading mix of the present invention relative to Mexican and/or Tex-Mex cultures. Three comparative food products were created and evaluated for texture, taste and appearance, wherein experience and credentials for judging authenticity of taste and appearance, during three independent tests, was provided by legal American citizens born and raised in Mexico.

The three comparative food products were each created on a chicken tenderloin base that was battered with white wheat flour mixed 1:1 with water. Group A was subsequently breaded with a conventional wheat flour breading; Group B was subsequently breaded with a conventional corn flour breading. Breading was prepared Group C, wherein corn taco shells were crushed to particle sizes having length and width measurements of approximately ¼-inch by ¼-inch, and thereafter mixed 50/50 with a white flour base. The Group C breading mix was applied with a consistent 26-28% pick-up to the pre-battered tenderloins. Each Group A, B and C was fully cooked in soybean oil for five (5) minutes at about 375° F. Results were consistently reported, as follows:

| | TEXTURE | TASTE | APPEARANCE |
|---|---|---|---|
| TEST 1-GROUP A | Very slight, | Not Mexican or | Not Mexican or |
| | Thin crispiness | Tex-Mex | Tex-Mex |
| TEST 1-GROUP B | Very slight, | Not Mexican or | Not Mexican or |
| | thin crispiness, | Tex-Mex | Tex-Mex |
| | but slightly | | |
| | crispier than | | |
| | Group A | | |
| TEST 1-GROUP C | Very crispy | Mexican/ | Mexican/ |
| | | Tex-Mex | Tex-Mex |
| TEST 2-GROUP A | Very slight, | Not Mexican or | Not Mexican or |
| | Thin crispiness | Tex-Mex | Tex-Mex |
| TEST 2-GROUP B | Very slight, | Not Mexican or | Not Mexican or |
| | thin crispiness, | Tex-Mex | Tex-Mex |
| | but slightly | | |
| | crispier than | | |
| | Group A | | |
| TEST 2-GROUP B | Very crispy | Mexican/ | Mexican/ |
| | | Tex-Mex | Tex-Mex |
| TEST 3-GROUP C | Very slight, | Not Mexican or | Not Mexican or |
| | Thin crispiness | Tex-Mex | Tex-Mex |
| TEST 3-GROUP C | Very slight, | Not Mexican or | Not Mexican or |
| | thin crispiness, | Tex-Mex | Tex-Mex |
| | but slightly | | |
| | crispier than | | |
| | Group A | | |
| TEST 3-GROUP C | Very crispy | Mexican/ | Mexican/ |
| | | Tex-Mex | Tex-Mex |

Thus, the crushed corn taco shell breading mix of the experiment was consistently reported as delivering an unexpectedly desirable Mexican and/or Tex-Mex organoleptic experience, even via minimized concentration of chip-based coating relative to that of prior art compositions.

### Crunchy Corn Ingredient of Preferred Breading

The preferred crushed corn taco shell breading ingredient of the present invention is prepared by crushing taco shells, as described above. However, other crunchy corn and/or corn-like ingredients may be utilized in place thereof, wherein, for example, tortilla and/or nacho chips may be crushed, or wherein pseudo-crushed chips may be created from base ingredients, such as via electrolytic processes, as opposed to derived from a whole chip or shell. It should be recognized that any suitable method could be utilized, wherein it is not the necessary ingredient of an actual crushed taco shell or tortilla chip that is required, although such is preferred, but the utilization of a suitably crunchy, accordingly flavored substitute, whether actually corn-based, or, for example, soy-based.

With respect to the preferred tortilla shell or chip composition, because the vast majority of U.S. corn and tortilla chips begin with corn masa flour, such flavor is preferred as a foundation for the present invention. It is recognized that a variety of colorations can be imparted to the chips, and hence to a final food product with the breading of the present invention applied thereto, via different types of corn. While these colors, such as red, blue, white and yellow, can be exploited for particular food products in order to enhance and/or further direct the overall organoleptic experience therefrom, any color may be utilized without departing from the present invention. Further, while any method of creating tortilla chips and/or shells may be utilized, one exemplary and preferred method begins with corn cooked in steam kettles with dry, powdered lime. After cooking, the steamed corn and lime suspension is preferably cooled and allowed to steep. Thereafter, washing of the mixture occurs and preferably, stones are utilized to mill the corn and form masa. Preferably, the masa is rolled to a preferred thickness, preferably between 0.10 in-0.03 in, whereafter the dough is cut into shapes and quickly baked at high temperatures to remove moisture. An equilibration step then evaporates residual moisture for more even physical formation during frying, wherein the final step preferably involves frying the chips in oil, such as, for exemplary purposes only, soybean oil, cottonseed oil, canola oil, or peanut oil. Alternatively, the final step may rely on baking in order to provide for an non-fried product. Coatings and seasonings may subsequently be applied, depending upon the particular desired end product. But, again, such seasoning would not depart from the intended scope of the present invention.

Further, although the experimental taco shell particles were reported as approximately ¼-inch by ¼-inch pieces, the preferred embodiment of the present invention comprises a plurality of particle sizes, preferably non-uniformly shaped. That is, while the ¼-inch dimension is suitable, and preferred as one of a plurality of particle sizes, other smaller dimensions may also be included, such as 1-millimeter, so long as the texture, crunch, and visible crushed-chip-like appearance is maintained. Moreover, larger dimensions may also be included, such as 1-inch, so long as the variations in texture of the breading layer due to the inconsistency in the chip application, both as visible and as discerned during eating, remain observable.

It is thus important to realize that known crumbs and/or particles would not be suitable for delivery of the preferred organoleptic experience. The preferred crunchy corn ingredient of the breading of the present invention enables delivery of an edible food coating with a variably textured exterior via incorporation of a plurality of non-uniform particle sizes. That is, the preferred breading mix of the present invention must comprise observable pieces or lumps, by way of variably oversized, interspersed, crunchy, crushed-like particles.

### Preferred Breading Mix

In a preferred embodiment of the present invention, the concentration of the crunchy, crushed corn ingredient present in the breading is preferably from about 1-59 weight percent (wt/wt %), more preferably from about 25-59 wt/wt %, with a preferred random distribution within the breading mix, and as applied to the coated or non-coated food product, for realization of preferred organoleptic properties.

Preferably, the breading mix of the present invention comprises yellow whole corn tortilla chips comprising vegetable oil (such as corn, soybean and/or sunflower oil, for example), bleached wheat flour, sugar, yeast and salt. The preferred batter of the present invention, preferably underlying the preferred breading mix, preferably includes spices, yellow corn flour, garlic powder, salt and wheat gluten. As noted, the preferred yellow whole corn tortilla chips may be replaced and/or mixed with other suitable crushed and/or flaked tortilla shells, taco shells, white, yellow or blue corn and/or baked or fried corn tortilla chips, or the like, wherein the preferred unique flavor experience is created via taste, smell, texture and feeling thereof. That is, the preferred chemosensation of the breading mix of the present invention provides for a specifically identifiable smell, taste, and temperature sensation via stimulation of olfactory cells, gustatory cells, and chemosensory mechanisms, and for delivery of particular flavor sensation via a defined textural experience based primarily upon the crushed chip component thereof. As such, the other mix components could be replaced, or added to, via inclusion of known food coating components, such as, without limitation, a powdered fat, other farinaceous materials, various binders (starch, soy protein), spices, such as, for example, onion powder, pepper, paprika, chili powder, hot pepper extract, and the like, various batter, dye and food-grade colors, and/or other suitable flavorings and colorings.

Preferably, the breading mix, as described, is shelf-stable, wherein application to virtually any food product is enabled. Further, the preferred breading mix is particularly useful for application to food products which are frozen for storage before use. However, it should be noted that the preferred crunchy corn breading and breading mix of the present invention is adapted for independent use relative to other food processing steps.

### Food Products

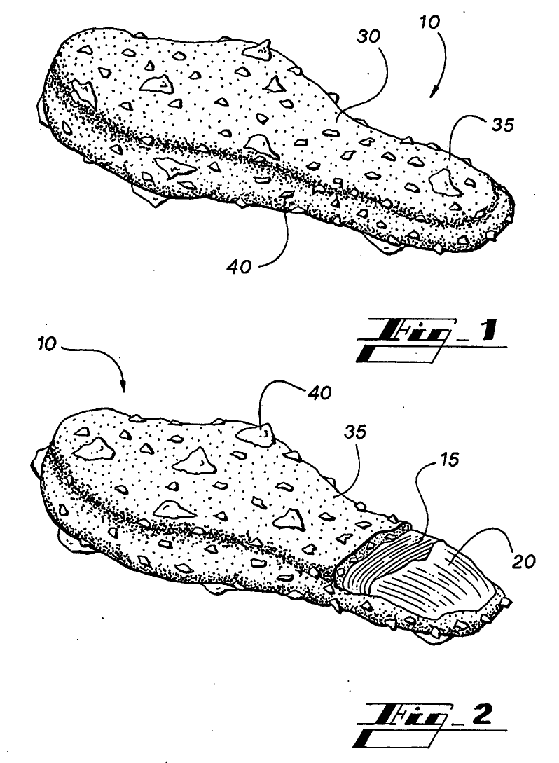

As noted above, virtually any meat, vegetable or food based product can be adapted into a shelf stable, refrigerated, or frozen Mexican taco-related organoleptic experience. That is, in a preferred embodiment of the present invention, a pre-breaded poultry product 10 is created, such as depicted in FIG. 1, and comprised of a breading mixture applied to a battered chicken tenderloin. It should be understood that the use of chicken as a base food product, although preferred, is exemplary in nature, and is not intended to be limiting in any way. Thus, the unique smell and taste experience that results from preferred marination, breading and flavoring processes of the present invention may be applied to virtually any edible food to make a food product having an outer coating comprised of visible crushed tortilla chip particles, randomly dispersed about a battered interior food component, thereby imparting a special crispness to a food product and delivering the perception of an exterior at least partially coated with crushed tortilla chip/taco shell pieces of varying shapes and sizes.

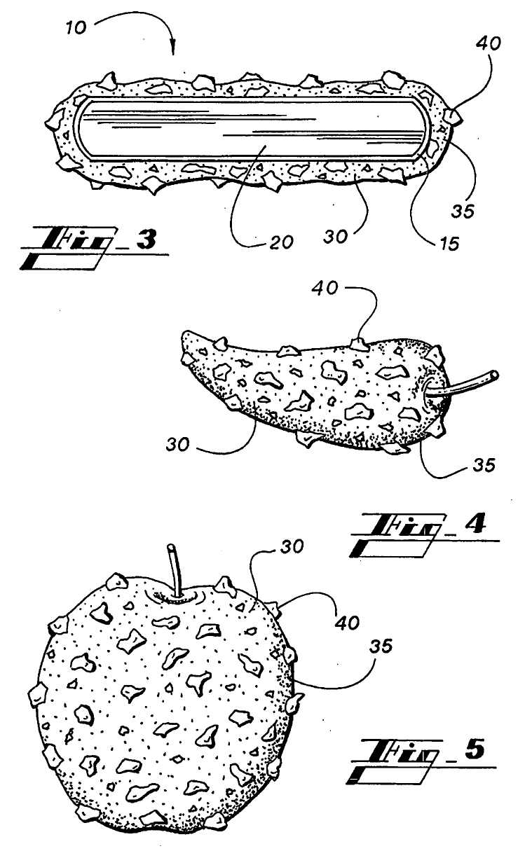

Referring now to FIGS. 1-3, preferred poultry food product 10 is shown, wherein preferred chicken tenderloin 20 is preferably prepared according to the process depicted in FIG. 6. Preferably, in marination preparation step 200 chicken tenderloin 20 is marinated, preferably via vacuum pumping with seasoning, wherein chicken tenderloin 20 soaks up taco and/or Mexican seasoning spices. Suitable marinade spicing preferably comprises chili pepper, taco seasoning, southwestern flavoring, and/or any other ingredient capable of delivering a base food product with a Mexican or taco-like taste, particularly and preferably suitable for combination with crunchy corn breading and breading mix according to the preferred embodiment of the present invention. It should be recognized that while vacuum pumping is preferred, any suitable marination method could be utilized. Also, although marination of chicken tenderloin 20 is preferred, marination preparation step 200 could alternately be omitted, wherein the overall flavoring of poultry food product 10 would be less, but the organoleptic experience delivered by preferred breading 30 would remain. Additionally, depending on the base food product, marination may not be desired. One example of a food product that would likely not require marination might be cheese, because generally, cheese flavor is selected at the time of creation, and is particularly suitable for combination with the breading and breading mix of the present invention.

Battering preparation step 210 preferably follows marination preparation step 200, wherein marinated chicken tenderloin 20 is preferably dropped or placed onto a belt or line for further processing. Marinated chicken tenderloin 20 preferably passes through an automated battering system, wherein, for example, batter 15 falls like a waterfall onto chicken tenderloin 20, essentially coating chicken tenderloin 20 with batter 15. Thereafter, in breading preparation step 220, preferably in a drum breader, battered chicken tenderloin 20 picks up preferred breading 30, which sticks or adheres thereto, preferably in a random and/or inconsistent pattern about outer surface 35 of preferred poultry food product 10. Preferably, a plurality of crunchy corn and/or corn-like particles 40, of a plurality of irregular shapes and dimensions, extend outwardly from outer surface 35 of preferred poultry food product 10, creating a texturally observable landscape. Again, although batter 15 is preferred, as described, in order to deliver an enhanced organoleptic experience, other edible coatings may be utilized in lieu thereof, such as, for exemplary purposes only, eggs, starch in water, chicken stock, milk, or any other desirable and suitable coating, wherein direct application of breading 30 to chicken tenderloin 20 is also a possibility, albeit with a decreased adherence.

Fryer preparation step 230 preferably follows, wherein breaded chicken tenderloin 20 is preferably partially cooked at around 145° F., to pre-brown and/or par-fry. Fryer preparation step 230 enables the adherence of the breading to the poultry 10. This preferred fryer preparation step 230 essentially serves to set and partially cook breading 30. Thus, poultry food products 10 that undergo preferred fryer preparation step 230 can bypass oven preparation step 240. Alternately, breaded chicken tenderloin 20 could be fried, steamed, char broiled, or fully cooked.

In preferred oven preparation step 240, breaded chicken tenderloin 20 preferably enters an oven and is fully cooked at about 165° F. Preferably thereafter at freezer preparation step 250, for food products intended for foodservice or retail packaging, breaded chicken tenderloin 20 is frozen, or individually quick frozen, preferably via a spiral freezer.

Alternately, via a raw breaded procedure, chicken tenderloin 30, whether marinated or not, may be placed on a line where it undergoes battering preparation step 210, followed by breading preparation step 220, whereafter at freezer preparation step 250, the raw breaded poultry food product 10 may be individually quick frozen, preferably via a spiral freezer, and packaged as desired.

Another alternative methodology for preparation of a food product with preferred breading 30 could begin with placement of ground and/or flaked chicken and/or chicken trimmings, or other various meats, into a forming machine. The selected meat parts could be marinated, or not, before placement into a hopper for transfer to a forming machine, wherein various sizes and shapes of meat products, such as patties, nuggets, tenders, rings, and the like may be stamped out. Thereafter, the stamped food product could proceed with the battering and breading methodology as described in more detail hereinabove, wherein preferred breading 30 would be applied thereto.

In still another alternate embodiment, as noted, the preferred crunch corn breading 30 of the present invention could be provided as a dry mix for purchase by a consumer. Such breading mix would enable a consumer to select and utilize any desired base food product for delivery of the taco, Mexican organoleptic experience.

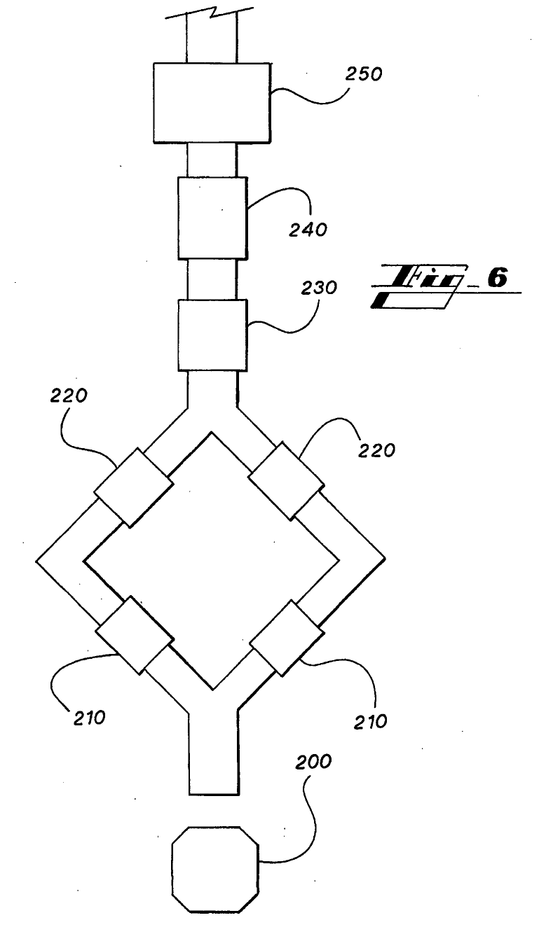

In another alternate embodiment, as noted hereinabove, preferred breading 30 could be applied to, for example, red meats, poultry, seafood, fish, vegetables, as depicted on a jalapeno popper in FIG. 4, mushrooms, cheese, fruit, as depicted on an apple in FIG. 5, and essentially any other edible base food item as desired.

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

I claim:

1) An edible breading for application to a food product, comprising:
crunchy corn-flavored particles present in about 2-59 WT %, said crunchy corn-flavored particles having an appearance of crushed tortilla chips; and
a farinaceous material present in about 41-98 WT %.

2) The edible breading of claim 1, wherein said farinaceous material is white flour.

3) The edible breading of claim 1, wherein said crunchy corn-flavored particles comprise crushed taco shells.

4) The edible breading of claim 1, wherein at least a portion of said corn-flavored particles is selected from the group comprising yellow corn tortilla chips, tortilla shells, taco shells, white corn tortilla chips, blue corn tortilla chips, baked corn tortilla chips, nacho chips and fried corn tortilla chips.

5) A breading mix for adapting a food product with a Mexican organoleptic experience, comprising:
crunchy corn-flavored particles present in about 2-25 WT %, said crunchy corn-flavored particles having an appearance of crushed tortilla chips;
a farinaceous material present in about 75-98 WT %;
sugar;
yeast; and
salt.

6) A method for creating a textured food product, comprising the steps of:
a) obtaining a base food;
b) applying a batter to said base food; and
c) thereafter applying a textured breading comprising crunchy corn-flavored particles of a plurality of shapes and sizes, wherein said crunchy corn-flavored particles are randomly applied about said base food, and wherein said applied textured breading comprises a non-uniform surface texture.

7. The method of claim 6, wherein said batter is selected from the group comprising eggs, aqueous starch solution, chicken stock, and milk.

8. The method of claim 6, wherein said base food is selected from the group comprising red meat, poultry, seafood, fish, vegetable, mushroom, cheese, fruit, whole chicken piece, and processed chicken piece.

9. The method of claim 6, wherein said crunchy corn-flavored particles are present in said textured breading in a concentration between 2-25%.

10. The edible breading of claim 1, wherein said crunchy corn-flavored particles comprise particles of a plurality of sizes, said sizes defined by a length and a width, and said sizes ranging from approximately 1 mm to 1 inch in length.

11. The breading mix of claim 5, wherein said crunchy corn-flavored particles are formed by electrolytic process.

12. The breading mix of claim 5, wherein said crunchy corn-flavored particles are soy-based.

13. The breading mix of claim 5, wherein said crunchy corn-flavored particles further comprise vegetable oil, flour, sugar, yeast and salt.

14. The breading mix of claim 5, further comprising additional ingredients selected from the group comprising spices, yellow corn flour, garlic powder, salt, wheat gluten, binder, powdered fat, onion powder, pepper, paprika, chili powder, hot pepper extract, dye, starch, and soy protein.

15. The method of claim 6, wherein said base food is marinated.

16. The method of claim 15, wherein said marinating is accomplished by vacuum pumping with plurality of seasoning.

17. The method of claim 16, wherein said plurality of seasoning is selected from the group comprising chili pepper, taco seasoning, and southwestern flavorings.

18. The method of claim 6, wherein said batter is applied in an automated battering system, wherein said base food advances on a belt or line, and said batter is gravitationally applied to said base food.

19. The method of claim 6, wherein said textured breading is applied in a drum breader.

20. The method of claim 6, further comprising the step of at least partially cooking said breaded base food, setting the adherence of said textured breading.

21. An organoleptically specialized chicken tender, filet, pattie, or tenderloin, comprising:
an exterior coating of crushed taco or tortilla shells of non-uniform size applied in a random, discontinuous surface arrangement.
